(19) United States
(12) Patent Application Publication
(10) Pub. No.: US 2026/0300017 A1
(43) Pub. Date: Oct. 1, 2026

(54) USING RESOURCE POOLS TO MANAGE WORKLOADS IN A CONTAINER ORCHESTRATION SYSTEM

(71) Applicant: Dell Products L.P., Round Rock, TX (US)

(72) Inventors: David Maddison, Weston (GB); Christophe A.D. Balczunas, Cumberland, RI (US); Praveen Kumar Lnu, Westborough, MA (US)

(21) Appl. No.: 19/090,123

(22) Filed: Mar. 25, 2025

(51) Int. Cl. G06F 9/50

(52) U.S. Cl. CPC G06F 9/5033; G06F 9/505; G06F 9/5083

(57) ABSTRACT

The technologies described herein are generally directed to using resource pools to manage workloads in a container orchestration system. For instance, a system can identify a processing workload and a container orchestration system. The system may further communicate a deployment request to a container controller of the container orchestration system to deploy the processing workload, in accordance with a custom resource pool operator. The deployment request may include a request to create a resource pool including a processing container and corresponding to a namespace, a request to deploy the processing workload to the processing container, and a request to the container controller to apply an affinity label that specifies to the container controller to host the processing workload in the processing container. The method may further include validating deployment of the processing workload corresponding to the namespace.

### BACKGROUND

Modern approaches to hosting applications may utilize different types of container systems to manage allocation of workloads to different nodes for processing. Different isolation levels may be required for workloads that are processed by nodes within the same container system. In some circumstances, workload applications may be developed and implemented in the same container system by different entities.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example method may include identifying a processing workload and a container orchestration system. The method may further include communicating a deployment request to a container controller of the container orchestration system to deploy the processing workload, in accordance with a custom resource pool operator. In embodiments, the deployment request may include a first request to the container controller to create a resource pool including at least one processing container and corresponding to a namespace, a second request to deploy the processing workload to the least one processing container, and a third request to the container controller to apply an affinity label that specifies to the container controller to host the processing workload in at the least one processing container corresponding to the namespace. The method may further include validating deployment of the processing workload to the at least one processing container corresponding to the namespace.

Additionally or alternatively, the resource pool may include a custom resource of the container orchestration system. Additionally or alternatively, the resource pool operator is applicable to request the container controller to validate that inclusion of the at least one processing container in the resource pool does not exceed an upper limit on number of available processing containers. Additionally or alternatively, the processing container corresponds to a computer system included in a cluster of computer systems hosting the container orchestration system. Additionally or alternatively, the deployment request further may include a fourth request to the container controller to apply a restriction to the at least one processing container of the resource pool, with the restriction specifying, to the container controller, not to allocate any other processing workloads other than the processing workload to the at least one processing container of the resource pool. Additionally or alternatively, the deployment request further may include a fifth request to the container controller to apply a toleration indication to the at least one processing container of the resource pool, with the toleration indication specifying, to the container controller, that the at least one processing container of the resource pool is permitted to host the processing workload.

Additionally or alternatively, the custom resource pool operator is applicable to request the container controller to create a resource quota custom data object in the namespace, the resource quota custom data object being applicable to limit resources assigned to the at least one processing container of the namespace. Additionally or alternatively, the resource quota object is further applicable to provide, to the processing workload, resource information corresponding to resources assigned to the at least one processing container of the namespace. Additionally or alternatively, the method may further include receiving a modification request to modify a number of the at least one processing container available to process the processing workload.

Additionally or alternatively, the method may further include employing the custom resource pool operator to alter a number of the least one processing container comprised in the namespace, resulting in an altered number of processing containers included in the namespace, with, as a result of carrying out the modification request, the resource quota custom data object being configured to update the resource information. Additionally or alternatively, based on the modification request, the resource quota custom data object may be further configured to, based on the altered number of processing containers update a number of restrictions applied to the at least one processing container of the resource pool, and update a number of toleration indications applied to the at least one processing container of the resource pool. Additionally or alternatively, the processing workload may include at least one of a distributed query process workload, or a distributed workflow process workload. Additionally or alternatively, the container orchestration system may be an open-source container orchestration system.

An example system can operate as follows. At least one memory may store computer executable instructions, and at least one processor may be configured to process the computer executable instructions that, when executed by the at least one processor, facilitate performance of operations. The operations may include receiving, from workload management controller equipment, an object request to generate a node pool custom data object, with the object request specifying, for a workload application, an application namespace, and nodes included in the application namespace that support processing of the workload application.

The operations may further include receiving, from the workload management controller equipment, an operator request to generate a node pool custom operator to manage the node pool custom data object in the container management system. The operations may further include, based on the node pool custom operator, restricting the nodes from being included in a different application namespace, and deploying the workload application to the nodes. Additionally or alternatively, the restricting of the nodes may include applying a taint to the nodes.

Additionally or alternatively, the operations may further include, based further on the node pool custom operator, applying an affinity label to the nodes, and the deploying of the workload application to the nodes includes, based on the affinity label, deploying the workload application to the nodes. Additionally or alternatively, the operations may further include, based further on the node pool custom operator, applying, to the workload application, a tolerance indication applicable to the application namespace, and the deploying of the workload application to the nodes includes, based on the tolerance indication, deploying the workload application to the nodes. Additionally or alternatively, the operations may further include, based further on the node pool custom operator, generating a custom resource quota object applicable to monitoring resources applied to the nodes.

An example non-transitory machine-readable medium may include executable instructions that, when executed by at least one processor, facilitate performance of operations. The operations may include generating a custom container pool object of a container orchestration system that includes a namespace of processing nodes applicable to process a workload application.

The operations may further include, based on a custom container pool operator, deploying the workload application to the namespace. The operations may further include, based on a custom resource quota operator, modifying the processing nodes included in the namespace. Additionally or alternatively, the modifying of the processing nodes may include modifying a taint applied to a first processing node of the processing nodes and modifying an affinity applied to a second processing node of the processing nodes. Additionally or alternatively, the operations may further include, based further on the custom resource quota operator, validating hosting of the workload application by the processing nodes. Additionally or alternatively, the operations may further include, based further on the custom resource quota operator, configuring the container orchestration system to prevent a change to a parameter of the processing nodes without use of the custom resource quota operator. Additionally or alternatively, the container orchestration system may include a Kubernetes container orchestration system, and the processing nodes may include worker nodes of the Kubernetes container orchestration system.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 is an architecture diagram of an example system that can facilitate using resource pools to manage workloads in a container orchestration system, in accordance with one or more embodiments,

FIG. 2 is an architecture diagram of an example system that can facilitate using resource pools to manage workloads in a container orchestration system, in accordance with one or more embodiments,

FIG. 3 includes a diagram that illustrates aspects of example system that can facilitate using resource pools to manage workloads in worker nodes of a container orchestration system, in accordance with one or more embodiments,

FIG. 4 includes a diagram that illustrates aspects of example system that can facilitate using a custom operator to manage workloads in namespaces of a container orchestration system, in accordance with one or more embodiments,

FIG. 5 includes a flow diagram of workflow deployment, with a description that references elements of FIG. 4, in accordance with one or more embodiments,

FIG. 6 depicts a flow diagram representing example operations that can facilitate using a resourcequota object to manage resources allocated to processing of workloads in a container orchestration system, in accordance with one or more embodiments,

FIG. 7 depicts an example of a resourcepool setup specification, in accordance with one or more embodiments,

FIG. 8 depicts a flow diagram representing example operations of an example method that can facilitate using resource pools to manage workloads in a container orchestration system, in accordance with one or more embodiments,

FIG. 9 depicts an example system that can facilitate using resource pools to manage workloads in a container orchestration system, in accordance with one or more embodiments,

FIG. 10 depicts an example non-transitory machine-readable medium that can include executable instructions that, when executed by a processor of a system, can facilitate using resource pools to manage workloads in a container orchestration system, in accordance with one or more embodiments,

FIG. 11 is a schematic block diagram of a system with which the disclosed subject matter can interact, and

FIG. 12 illustrates an example block diagram of a computer operable to execute an embodiment of this disclosure.

### DETAILED DESCRIPTION

Various specific details of the disclosed embodiments are provided in the description below. One skilled in the relevant art(s) will recognize, however, that the techniques described herein can in some cases be practiced without one or more of the specific details, or with other methods, components, materials, etc. In other instances, well-known structures, materials, or operations are not shown or described in detail to avoid obscuring subject matter.

By utilizing one or more implementations as described herein, the performance, efficiency, and management of systems that orchestrate and manage containerized workloads and services may be improved, e.g., by providing different approaches to managing the information available to processing containers, managing interactions between processing containers with the same and different workloads, and managing the computer system resources allocated to different processing containers. One or more embodiments described herein are not abstract concepts; rather, they provide technical solutions to technical problems associated with the interaction of different computer system components allocated to different types of processing workloads in onsite and cloud-based system deployments. Moreover, implementations described herein can provide these solutions in a manner that cannot reliably be performed by a human or even a plurality of humans, e.g., solutions provided are based on improving the operation of complex, networked systems, while restricting the flow of information within interconnected hardware and software components.

Aspects of the subject disclosure will now be described more fully hereinafter with reference to the accompanying drawings in which example components, graphs and operations are shown. In the following description, for purposes of explanation, numerous specific details are set forth in order to provide a thorough understanding of the various embodiments. However, the subject disclosure may be embodied in many different forms and should not be construed as limited to the examples set forth herein.

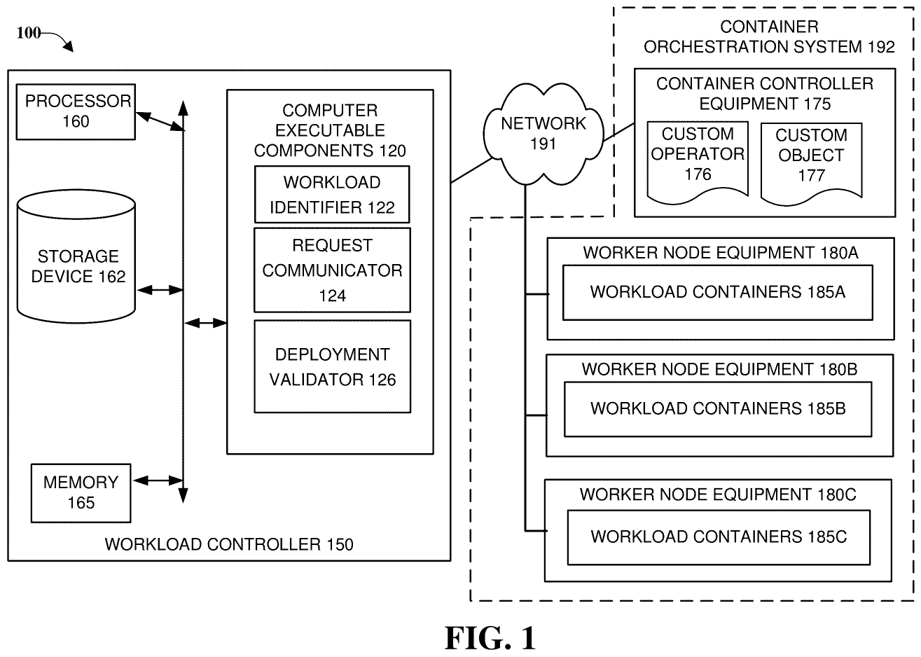

FIG. 1 is an architecture diagram of an example system 100 that can facilitate using resource pools to manage workloads in a container orchestration system, in accordance with one or more embodiments. For purposes of brevity, description of like elements and/or processes employed in other embodiments is omitted.

As depicted, system 100 includes workload controller 150, network 191, and container orchestration system 192. Container orchestration system 192 includes container controller equipment 175, and worker node equipment 180A-C, which respectively include workload containers 185A-C. Controller equipment 175 includes custom operator 176 and custom object 177. Workload controller 150 is connected, via network 191, to container controller equipment 175 and worker node equipment 180A-C.

As depicted, workload controller 150 can include memory 165 that can store one or more computer and/or machine readable, writable, and/or executable components 120 and/or instructions. In embodiments, workload controller 150 can further include processor 160. In one or more embodiments, computer executable components 120, when executed by processor 160, can facilitate performance of operations defined by the executable component(s) and/or instruction(s). Computer executable components 120 can include workload identifier 122, request communicator 124, deployment validator 126, and other components described or suggested by different embodiments described herein, that can improve the operation of system 100. Workload controller 150 may further include storage device 162. In an example, storage device 162 may provide nonvolatile storage of data, data structures, computer executable instructions, and so forth.

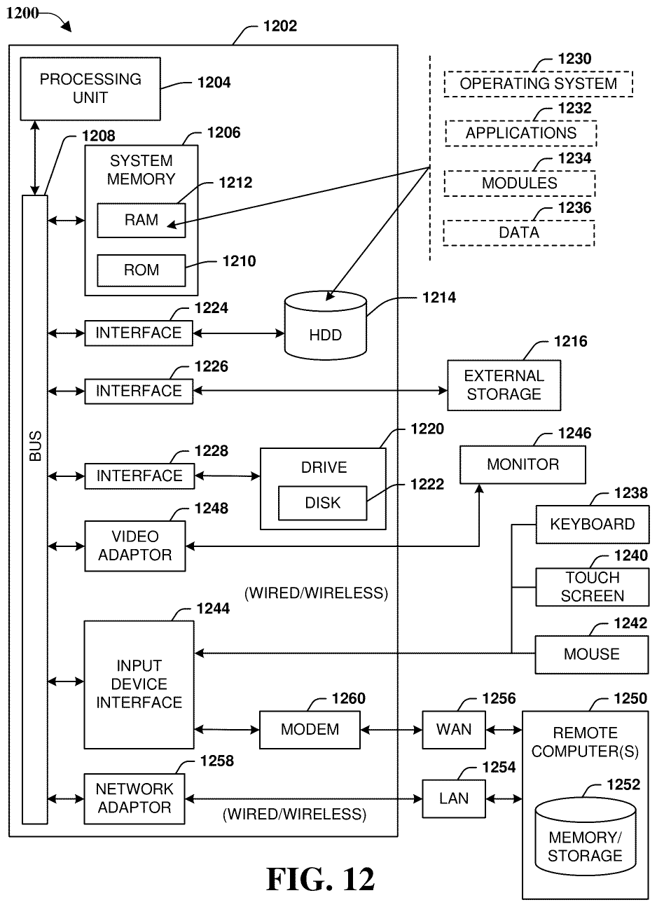

According to multiple embodiments, processor 160 can comprise one or more processors and/or electronic circuitry that can implement one or more computer and/or machine readable, writable, and/or executable components and/or instructions that can be stored on memory 165. For example, processor 160 can perform various operations that can be specified by such computer and/or machine readable, writable, and/or executable components and/or instructions including, but not limited to, logic, control, input/output (I/O), arithmetic, and/or the like. In some embodiments, processor 160 can comprise one or more components including, but not limited to, a central processing unit, a multi-core processor, a microprocessor, dual microprocessors, a microcontroller, a System on a Chip (SOC), an array processor, a vector processor, and other types of processors. Further examples of processor 160 are described below with reference to processing unit 1204 of FIG. 12. Such examples of processor 160 can be employed to implement any embodiments of the subject disclosure.

In some embodiments, memory 165 can comprise volatile memory (e.g., random access memory (RAM), static RAM (SRAM), dynamic RAM (DRAM), etc.) and/or non-volatile memory (e.g., read only memory (ROM), programmable ROM (PROM), electrically programmable ROM (EPROM), electrically erasable programmable ROM (EEPROM), etc.) that can employ one or more memory architectures. Further examples of memory 165 are described below with reference to system memory 1206 and FIG. 12. Such examples of memory 165 can be employed to implement any embodiments of the subject disclosure.

In one or more embodiments, computer executable components 120 can be used in connection with implementing one or more of the systems, devices, components, and/or computer-implemented operations shown and described in connection with FIG. 1 or other figures disclosed herein. In an example, memory 165 can store executable instructions that can facilitate generation of workload identifier 122, which can in some implementations can identify a processing workload and a container orchestration system. For example, in one or more embodiments, workload identifier 122 may identify a processing workload and a container orchestration system. For example, in one or more embodiments, workload identifier 122 can identify a query processing workload hosted by workload containers 185A-C of container orchestration system 192.

In another example, memory 165 can store executable instructions that can facilitate generation of request communicator 124, which in some implementations may communicate a deployment request to a container controller of the container orchestration system to deploy the processing workload, in accordance with a custom resource pool operator. In an example, the deployment request may include a first request to the container controller to create a resource pool including at least one processing container and corresponding to a namespace, a second request to deploy the processing workload to the least one processing container, and a third request to the container controller to apply an affinity label that specifies to the container controller to host the processing workload in at the least one processing container corresponding to the namespace. For example, in one or more embodiments, request communicator 124 can communicate a deployment request to container controller equipment 175 of container orchestration system 192 to deploy the query processing workload, in accordance with custom operator 176, e.g., a custom resourcepool operator. In an example, the deployment request may include a first request to container controller equipment 175 to create custom object 177 (e.g., a custom resource pool object) including workload containers 185A-C and corresponding to a namespace, a second request to deploy the query processing workload to workload containers 185A-C, and a third request container controller equipment 175 to apply an affinity label that specifies to container controller equipment 175 to host the query processing workload in workload containers 185A-C, corresponding to the namespace.

In another example, memory 165 can store executable instructions that can facilitate generation of deployment validator 126, which in some implementations may validate deployment of the processing workload to the at least one processing container corresponding to the namespace. For example, in one or more embodiments, deployment validator 126 may validate deployment of the query processing workload to workload containers 185A-C corresponding to the namespace.

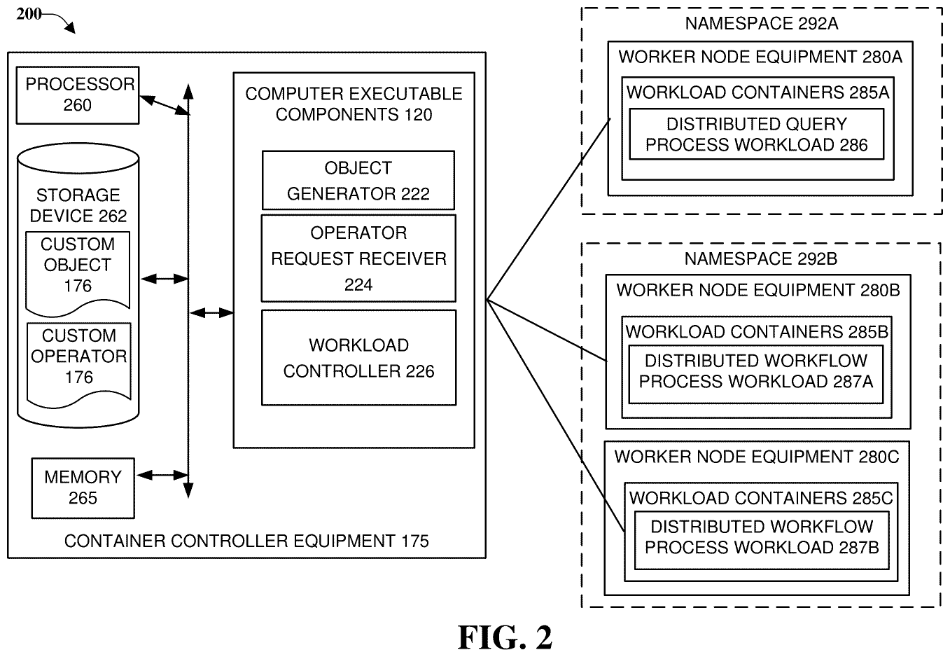

FIG. 2 is an architecture diagram of an example system 200 that can facilitate using resource pools to manage workloads in a container orchestration system, in accordance with one or more embodiments. For purposes of brevity, description of like elements and/or processes employed in other embodiments is omitted. As depicted, system 200 includes container controller equipment 175 and namespaces 292A-B. Container controller equipment 175 is connected to worker node equipment 280A-C, with worker node equipment 280A included in namespace 292A, and worker node equipment 280B-C included in namespace 292B. Worker node equipment 280A includes workload container 285A, hosting distributed query process workload 286. Worker node equipment 280B-C respectively includes workload containers 285B-C, respectively hosting distributed workflow process workload 287A-B.

Container controller equipment 175 includes processor 260, memory 265, storage device 262, and computer executable components 220. Worker node equipment

In embodiments, processor 260 is similar to processor 160 and storage device 262 is similar to storage device 162, discussed above. According to multiple embodiments, memory 265 can store one or more computer and/or machine readable, writable, and/or executable components 220 and/or instructions. In one or more embodiments, computer executable components 220, when executed by processor 260, can facilitate performance of operations defined by the executable component(s) and/or instruction(s). Computer executable components 220 can include object generator 222, operator request receiver 224, workload controller 226, and other components described or suggested by different embodiments described herein, e.g., that can improve the operation of system 200, in accordance with one or more embodiments.

In an example implementation of container controller equipment 175, memory 265 can store executable instructions that can facilitate generation of object generator 222, which in some implementations, may generate a custom container pool object of a container orchestration system including a namespace of processing nodes applicable to process a workload application. For example, one or more embodiments, object generator 222 may generate a custom object 177 (e.g., the custom container pool object) of container orchestration system 192 including namespace 292B of worker node equipment 280B-C applicable to process a distributed workflow process via workload containers 285B-C.

In an example implementation of container controller equipment 175, memory 265 can further store executable instructions that can facilitate generation of operator request receiver 224, which in some implementations, may, based on a custom container pool operator, deploy the workload application to the namespace. For example, in one or more embodiments, operator request receiver 224 may, based on custom (container pool) operator 176 (e.g., custom container pool operator), deploy distributed workflow process workload 285B-C to workload containers 285B-C of worker node equipment 280B-C respectively, included in namespace 292B.

In an example implementation of container controller equipment 175, memory 265 can further store executable instructions that can facilitate generation of workload controller 226, which in some implementations, may, based on a custom resource quota operator, modify the processing nodes included in the namespace, with the modifying including modifying a taint applied to a first processing node of the processing nodes and modifying an affinity applied to a second processing node of the processing nodes. For example, in one or more embodiments, workload controller 226 may, based on another custom operator 176 (e.g., custom resource quota operator), variously apply a taint and/or an affinity to worker node equipment 280B-C.

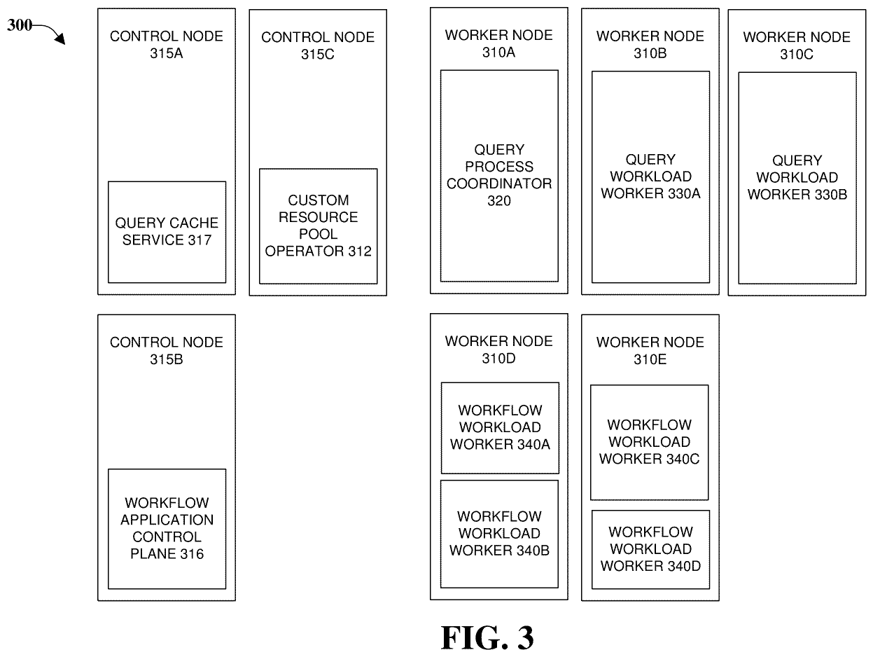

FIG. 3 includes a diagram that illustrates aspects of example system 300 that can facilitate using resource pools to manage workloads in worker nodes of a container orchestration system, in accordance with one or more embodiments. For purposes of brevity, description of like elements and/or processes employed in other embodiments is omitted. System 300 includes control nodes 315A-C and worker nodes 310A-E. Control node 315A includes query service cache 317, control node 315B includes workflow application control plane 316, and worker node 315C includes custom resource pool operator 312. Worker node 310A includes query process coordinator 320, and worker nodes 310B-C include query workload workers 330A-B, respectively. Worker node 310D includes workflow workload worker 340A-B, and Worker node 310E includes workflow workload workers 340C-D.

In one or more embodiments, worker nodes 310A-E may correspond to server equipment hosting a container orchestration system cluster. An example implementation may host a KUBERNETES (™) container orchestration system. In an implementation, the query workload application of worker nodes 310A-C can be the of the STARBURST ENTERPRISE (™) platform. In an implementation, the workflow workload application of worker nodes 310D-E can be the of the APACHE SPARK (™) distributed data processing framework.

In some implementations, different entities may utilize and maintain different workloads hosted by containers in the container orchestration system. One or more embodiments may facilitate defining a specific workload for a given node and for the workload to be correctly allocated even when a third party provides that workload. For example, workflow application control plane 316 may be generated by a third party, and one or more embodiments may constrain workflow workload workers 340A-D to respective nodes 310D-E. In an implementation, workflow workload workers nodes 310A-D may operate in a container as if unrestricted, e.g., the process is governed by restrictions that are not detectable by the process. In embodiments, the restrictions described herein may be implemented and enforced without modification of the restricted workloads.

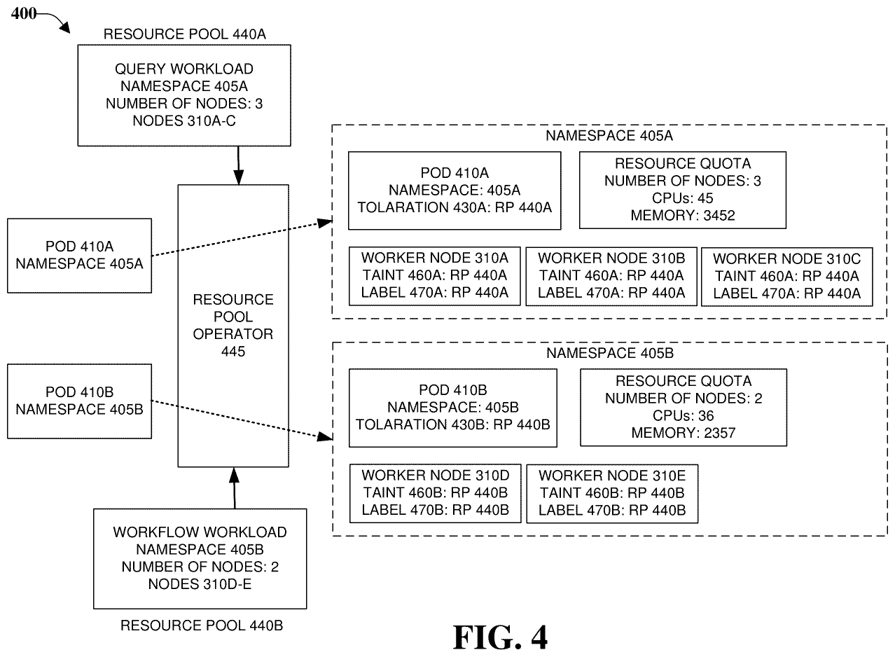

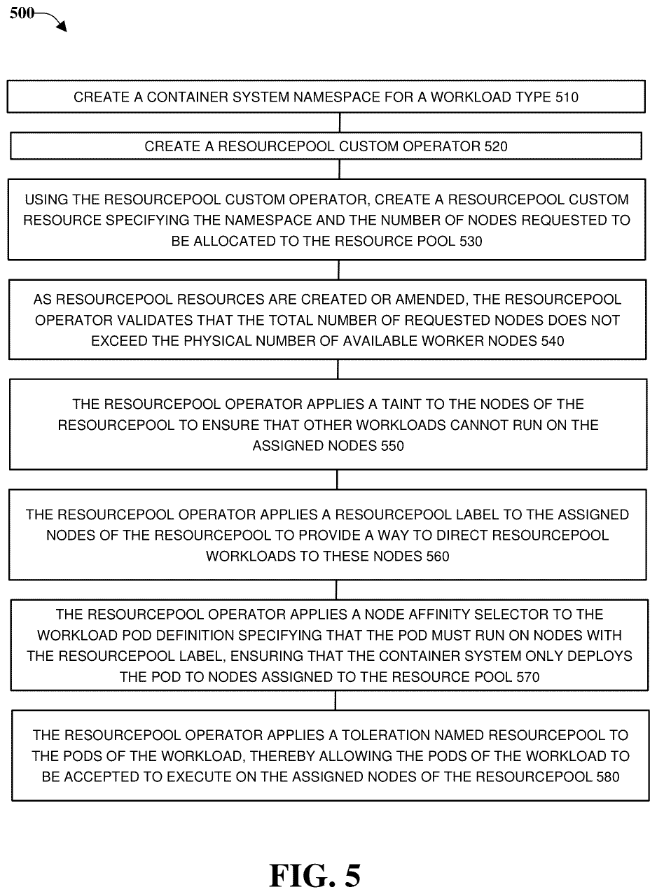

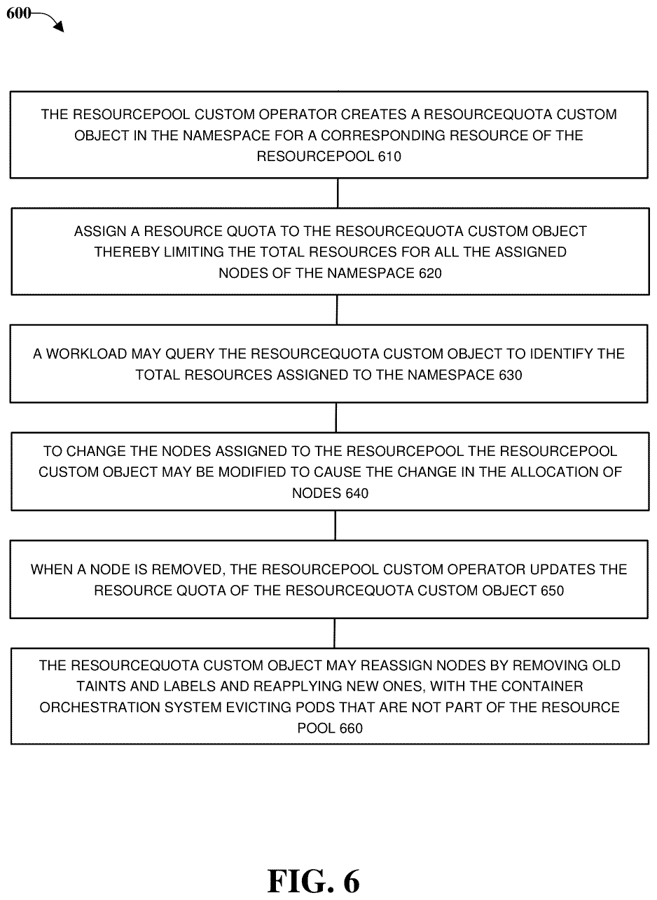

FIGS. 4-6 are described below, with FIG. 4 including an architectural diagram with different elements of embodiments shown. FIG. 5 includes a flow diagram of workflow deployment, with a description that references elements of FIG. 4, in accordance with one or more embodiments. FIG. 6 includes a flow diagram of different processes that may be used to monitor and manage resources allocated to workflows, in accordance with one or more embodiments.

FIG. 4 includes a diagram that illustrates aspects of example system 400 that can facilitate using a custom operator to manage workloads in namespaces of a container orchestration system, in accordance with one or more embodiments. For purposes of brevity, description of like elements and/or processes employed in other embodiments is omitted. System 400 includes pods 410A-B respectively utilizing resource pool operator 455 based on resource pools 440A-B, respectively, to generate and administer namespaces 405A-B. Resourcepool 440A is designated to handle the query application, and resourcepool 440B is designated to handle the workflow application. Resourcepool 440A is defined as being directed to namespace 405A having worker nodes 310A-C, and resourcepool 440B is defined as being directed to namespace 405B having worker nodes 310D-E. The pod of the query application has toleration 430A assigned and the pod of the workflow application has the toleration 430B assigned. Label 470A is applied to worker nodes 310A-C and label 470B is applied to worker nodes 310D-E. Taint 460A is applied to worker nodes 310A-C and taint 460B is applied to worker nodes 310D-E.

At 510, a container system namespace for a workload type is created. For example, as depicted in FIG. 4, namespace 405A may be created for the query workload type. At 520, a resourcepool custom operator is created. In an example, resourcepool custom operator 445 may be created which allows creation of resourcepool 440A.

At 530, using the resourcepool custom operator, a resourcepool custom resource is created specifying the namespace and the number of nodes requested to be allocated to the resourcepool. In one or more embodiments, the resourcepool custom operator may be used to initiate setup of each workload type. Each resourcepool custom object resource specifies a namespace and the number of nodes to allocate for that resource type. As depicted in FIG. 4, resourcepool 440A was created along with namespace 405A, and nodes 310A-C were allocated to resourcepool 440A. In an implementation, during the setup of the resource pool, a number of nodes may be specified, and the resourcepool custom operator may select the required number of nodes for the pool from unassigned nodes, e.g., randomly, by performance, and/or other approaches.

At 540, as resourcepool resources are created or amended, the resourcepool custom operator validates that the total number of requested nodes does not exceed the physical number of available worker nodes. In embodiments, deployment validator 126 may be used to perform different validation functions. At 550, the resourcepool custom operator may apply a taint to the nodes of the resourcepool to ensure that other workloads cannot run on the assigned nodes, e.g., taint 460A for the query workload is applied to worker nodes 310A-C and taint 460B for the workflow workload is applied to worker nodes 310D-E. In a Kubernetes implementation, a Kubernetes Taint may be applied to the nodes named “resource-pool <resourcepool name>,” thereby ensuring that other workloads cannot run on the nodes assigned to the resourcepool.

At 560, the resourcepool operator applies a resourcepool label to the assigned nodes of the resourcepool to provide a way to direct resourcepool workloads to these nodes, e.g., label 470A applied to worker nodes 310A-C and label 470B applied to worker nodes 310D-E. In a Kubernetes implementation, a Kubernetes label may also be applied to nodes using “resource-pool-<resourcepool-name>,” thereby providing a way to direct resourcepool workloads to the nodes assigned to the resourcepool. In one or more embodiments, not all available nodes must be assigned to a resourcepool. In such instances unassigned nodes would not contain a taint or label.

At 570, the resourcepool operator applies a node affinity selector to the workload pod definition specifying that the pod must run on nodes with the resourcepool label, ensuring that the container system only deploys the pod to nodes assigned to the resource pool. In a Kubernetes implementation, a Kubernetes node affinity selector may be nodes assigned to the resourcepool, e.g., specifying the node must run on node with the “resource-pool-<resourcepool-name>” label. In an implementation, this ensures Kubernetes only considers nodes assigned to the resource pool.

At 580, the resourcepool operator applies a toleration named resourcepool to the pod definition of the workload to be executed within the assigned nodes. In embodiments, the toleration applied to the workload pod allows the pods to be accepted on a corresponding node with the taint applied as described with 550. In a Kubernetes implementation, a Kubernetes toleration named “resource-pool-<resourcepool-name>,” (toleration 430A) may be applied to the query workload, e.g., allowing the workload to be accepted to execute on the assigned nodes. In an implementation, using the namespace to apply tolerations allows embodiments to control the acceptance of workloads by assigned nodes, without the workload being aware of the resourcepool allocation. In embodiments, due to taints applied to assigned nodes the Kubernetes scheduler cannot schedule workloads outside of resourcepool 440A to a node assigned to resourcepool 440A.

In an implementation, daemon sets, which may be used to deploy the same workload on all nodes, may be used by embodiments for global workloads that are deployed on nodes of multiple resourcepools, e.g., ingress endpoints. In one or more embodiments, for global workloads, the resourcepool custom operator may accommodate the installation of global workloads across namespaces by adding all necessary tolerations from multiple resourcepools, e.g., ensuring daemon sets can operate seamlessly across the cluster.

FIG. 6 depicts a flow diagram representing example operations 600 that can facilitate using a resourcequota object to manage resources allocated to processing of workloads in a container orchestration system, in accordance with one or more embodiments. For purposes of brevity, description of like elements and/or processes employed in other embodiments is omitted. In one or more embodiments, while resources may be assigned to workloads automatically by the resourcepool custom operator, in some circumstances workloads may have a requirement to determine the resources allocated to respective resourcepools. As depicted in FIG. 6, embodiments may use different operations to facilitate manipulating resources of resourcepools, and the discovery of resources by different workloads.

At 610, the resourcepool custom operator creates a resourcequota custom object in the namespace for a corresponding resource of the resourcepool. In a Kubernetes implementation, a Kubernetes resourcepool custom operator may create a standard Kubernetes resourcequota object in a namespace for a resourcepool custom object. At 620, a resource quota is assigned to the resourcequota custom object, thereby limiting the total resources for all the assigned nodes of the namespace. In an implementation, the limits in the Kubernetes resourcequota may be set to the total resources for all assigned nodes of the resourcepool. At 630, a workload may query the resourcequota custom object to identify the total resources assigned to the namespace.

At 640, to change the nodes assigned to the resourcepool the resourcepool custom object may be modified to cause the change in the allocation of nodes. At 650, when a node is removed, the resourcepool custom operator updates the resource quota of the resourcequota custom object. In an implementation, when nodes of a resourcepool are reduced, the resourcepool custom operator may select a node to remove based on different criteria, e.g., prioritizing for removal nodes that are not currently running high-priority workloads. In an embodiment, the resourcepool custom operator may update the resources of the resourcequota and reassign nodes by removing old taints and labels and reapplying new to handle the changes to the node allocations. At 660, the resourcequota custom object may reassign nodes by removing old taints and labels and reapplying new ones, with the container orchestration system evicting pods that are not part of the resource Pool.

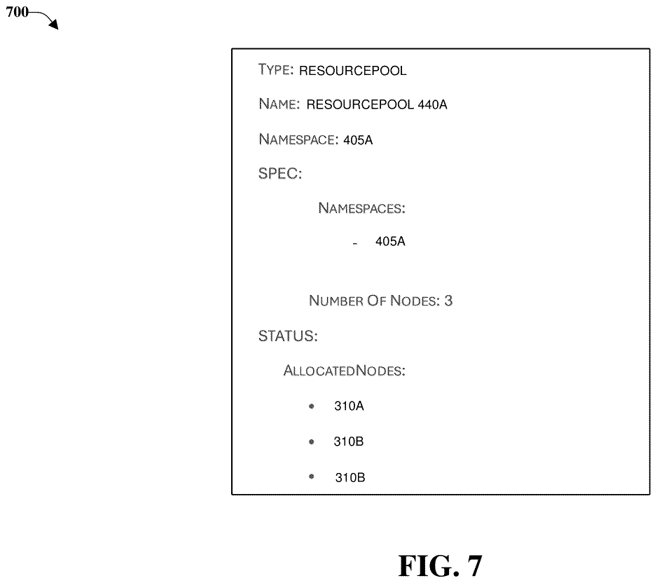

FIG. 7 depicts an example 700 resourcepool setup specification, in accordance with one or more embodiments. For purposes of brevity, description of like elements and/or processes employed in other embodiments is omitted. As depicted, example 700 includes a specification for resourcepool 440A, including namespace 405A and allocated worker nodes 310A-C.

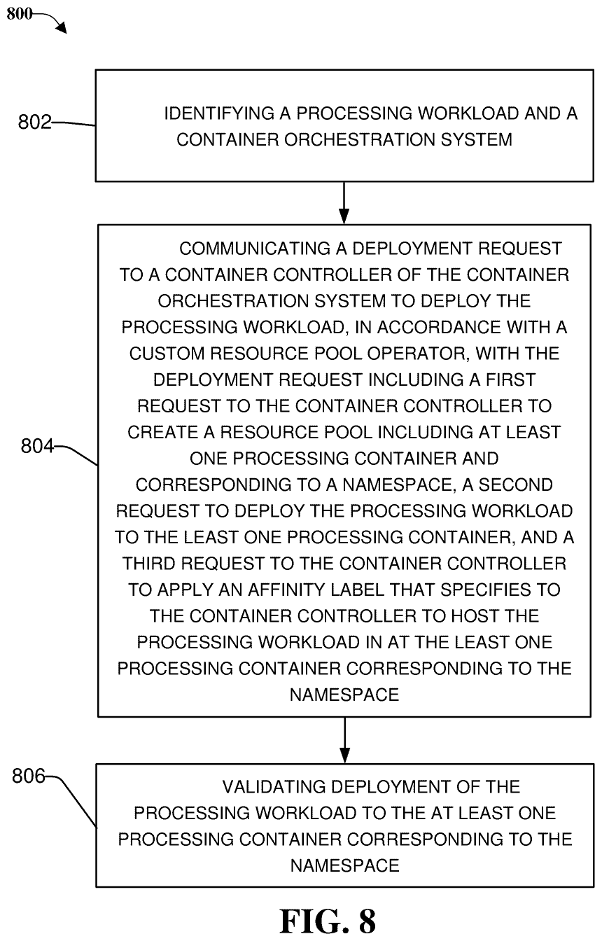

FIG. 8 depicts a flow diagram representing example operations of an example method 800 that can facilitate using resource pools to manage workloads in a container orchestration system, in accordance with one or more embodiments. For purposes of brevity, description of like elements and/or processes employed in other embodiments is omitted. In some examples, one or more embodiments of method 800 can be implemented by workload identifier 122, request communicator 124, deployment validator 126, and other components that can be used to implement aspects of method 800, in accordance with one or more embodiments. FIG. 8, described below illustrates methods in accordance with certain embodiments of this disclosure. While, for purposes of simplicity of explanation, the methods have been shown and described as series of acts, it is to be understood and appreciated that this disclosure is not limited by the order of acts, as some acts may occur in different orders and/or concurrently with other acts from that shown and described herein. For example, those skilled in the art will understand and appreciate that methods can alternatively be represented as a series of interrelated states or events, such as in a state diagram. Moreover, not all illustrated acts may be required to implement methods in accordance with certain embodiments of this disclosure.

At 802 of method 800, workload identifier 122 of workload controller 150 can identify a processing workload and a container orchestration system. At 804 of method 800, request communicator 124 can communicate a deployment request to a container controller of the container orchestration system to deploy the processing workload, in accordance with a custom resource pool operator. In an example, the deployment request may include a first request to the container controller to create a resource pool including at least one processing container and corresponding to a namespace, a second request to deploy the processing workload to the least one processing container, and a third request to the container controller to apply an affinity label that specifies to the container controller to host the processing workload in at the least one processing container corresponding to the namespace. At 806 of method 800, deployment validator 126 can validate deployment of the processing workload to the at least one processing container corresponding to the namespace.

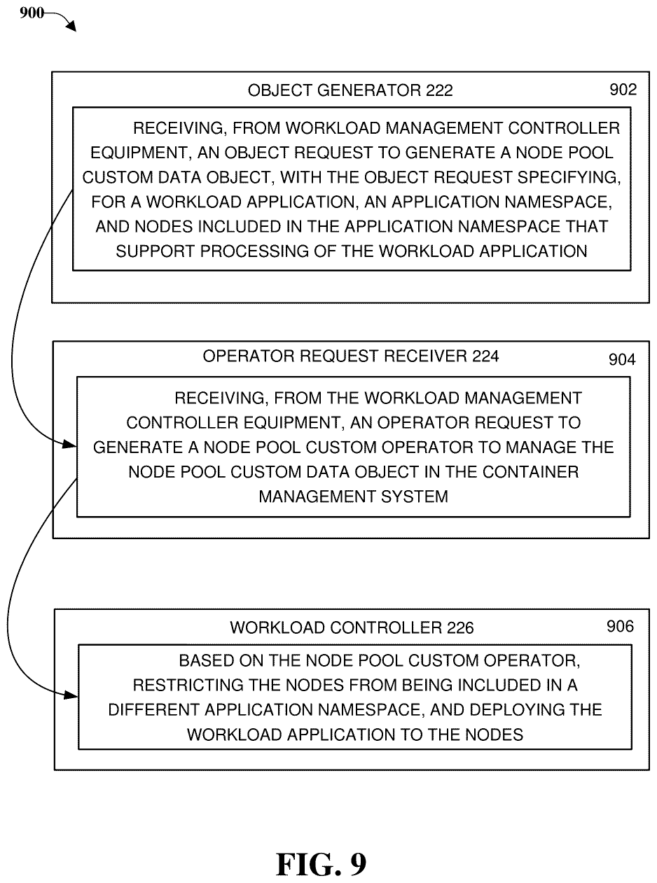

FIG. 9 depicts an example system 900 that can facilitate using resource pools to manage workloads in a container orchestration system, in accordance with one or more embodiments. For purposes of brevity, description of like elements and/or processes employed in other embodiments is omitted. System 900 includes at least one memory that stores computer executable components, and at least one processor that executes the computer executable components stored in the at least one memory, with the computer executable components including object generator 222, operator request receiver 224, workload controller 226, and other components that can be used to implement aspects of system 900, as described herein, in accordance with one or more embodiments.

At 902 of FIG. 9, object generator 222 can generate a custom container pool object of a container orchestration system including a namespace of processing nodes applicable to process a workload application. At 904 of FIG. 9, operator request receiver 224 can, based on a custom container pool operator, deploy the workload application to the namespace. At 906 of FIG. 9, workload controller 226 can, based on a custom resource quota operator, modify the processing nodes included in the namespace, with the modifying including modifying a taint applied to a first processing node of the processing nodes and modifying an affinity applied to a second processing node of the processing nodes.

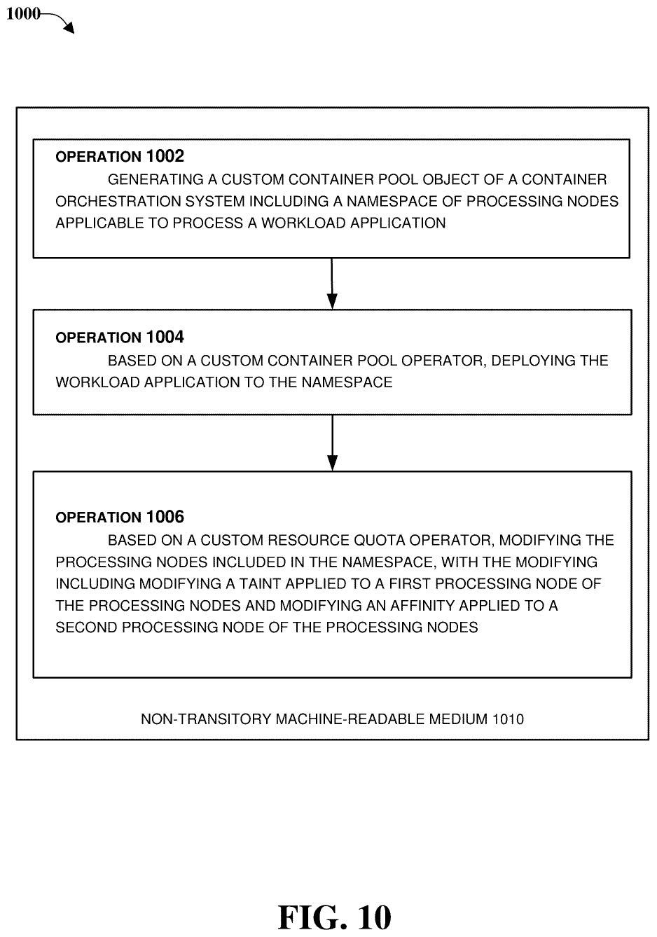

FIG. 10 depicts an example 1000 non-transitory machine-readable medium 1010 that can include executable instructions that, when executed by a processor of a system, can facilitate using resource pools to manage workloads in a container orchestration system, in accordance with one or more embodiments. For purposes of brevity, description of like elements and/or processes employed in other embodiments is omitted.

As depicted, non-transitory machine-readable medium 1010 includes executable instructions that, when executed by at least one processor of a machine learning device, facilitate performance of operations that include operation 1002 which can generate a custom container pool object of a container orchestration system that includes a namespace of processing nodes applicable to process a workload application. The operations may further include operation 1004 which can, based on a custom container pool operator, deploy the workload application to the namespace. The operations may further include operation 1006 which can, based on a custom resource quota operator, modifying the processing nodes comprised in the namespace, wherein the modifying of the processing nodes includes modifying a taint applied to a first processing node of the processing nodes and modifying an affinity applied to a second processing node of the processing nodes.

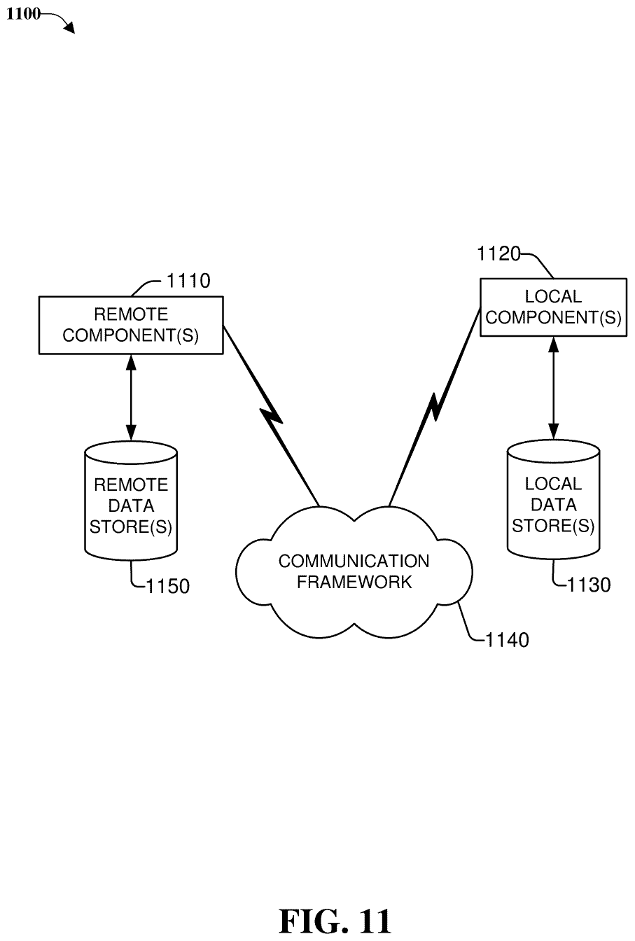

FIG. 11 is a schematic block diagram of a system 1100 with which the disclosed subject matter can interact. The system 1100 comprises one or more remote component(s) 1110. The remote component(s) 1110 can be hardware and/or software (e.g., threads, processes, computing devices). In some embodiments, remote component(s) 1110 can be a distributed computer system, connected to a local automatic scaling component and/or programs that use the resources of a distributed computer system, via communication framework 1140. Communication framework 1140 can comprise wired network devices, wireless network devices, mobile devices, wearable devices, RAN devices, gateway devices, femtocell devices, servers, etc. The system 1100 also comprises one or more local component(s) 1120. The local component(s) 1120 can be hardware and/or software (e.g., threads, processes, computing devices).

One possible communication between a remote component(s) 1110 and a local component(s) 1120 can be in the form of a data packet adapted to be transmitted between two or more computer processes. Another possible communication between a remote component(s) 1110 and a local component(s) 1120 can be in the form of circuit-switched data adapted to be transmitted between two or more computer processes in radio time slots. The system 1100 comprises a communication framework 1140 that can be employed to facilitate communications between the remote component(s) 1110 and the local component(s) 1120, and can comprise an air interface, e.g., Uu interface of a UMTS network, via a long-term evolution (LTE) network, etc. Remote component(s) 1110 can be operably connected to one or more remote data store(s) 1150, such as a hard drive, solid state drive, SIM card, device memory, etc., that can be employed to store information on the remote component(s) 1110 side of communication framework 1140. Similarly, local component(s) 1120 can be operably connected to one or more local data store(s) 1130, that can be employed to store information on the local component(s) 1120 side of communication framework 1140.

In order to provide a context for the various aspects of the disclosed subject matter, the following discussion is intended to provide a brief, general description of a suitable environment in which the various aspects of the disclosed subject matter can be implemented. While the subject matter has been described above in the general context of computer executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

In the subject specification, terms such as “store,” “storage,” “data store,” “data storage,” “database,” and substantially any other information storage component relevant to operation and functionality of a component, refer to “memory components,” or entities embodied in a “memory” or components comprising the memory. It is noted that the memory components described herein can be either volatile memory or non-volatile memory, or can comprise both volatile and non-volatile memory, for example, by way of illustration, and not limitation, volatile memory 1020 (see below), non-volatile memory 1022 (see below), disk storage 1024 (see below), and memory storage, e.g., local data store(s) 1130 and remote data store(s) 1150, see below. Further, nonvolatile memory can be included in read only memory, programmable read only memory, electrically programmable read only memory, electrically erasable read only memory, or flash memory. Volatile memory can comprise random access memory, which acts as external cache memory. By way of illustration and not limitation, random access memory is available in many forms such as synchronous random-access memory, dynamic random access memory, synchronous dynamic random access memory, double data rate synchronous dynamic random access memory, enhanced synchronous dynamic random access memory, SynchLink dynamic random access memory, and direct Rambus random access memory. Additionally, the disclosed memory components of systems or methods herein are intended to comprise, without being limited to comprising, these and any other suitable types of memory.

Moreover, it is noted that the disclosed subject matter can be practiced with other computer system configurations, comprising single-processor or multiprocessor computer systems, mini-computing devices, mainframe computers, as well as personal computers, hand-held computing devices (e.g., personal digital assistant, phone, watch, tablet computers, netbook computers), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in different systems, e.g., both local and remote memory storage devices.

Referring now to FIG. 12, in order to provide additional context for various embodiments described herein, FIG. 12 and the following discussion are intended to provide a brief, general description of a suitable computing environment 1200 in which the various embodiments described herein can be implemented.

While the embodiments have been described above in the general context of computer executable instructions that can run on one or more computers, those skilled in the art will recognize that the embodiments can also be implemented in combination with other program modules and/or as a combination of hardware and software. For purposes of brevity, description of like elements and/or processes employed in other embodiments is omitted.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data, or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory, or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries, or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and may include any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 12, the example environment 1200 for implementing various embodiments of the aspects described herein includes a computer 1202, the computer 1202 including a processing unit 1204, a system memory 1206 and a system bus 1208. The system bus 1208 couples system components including, but not limited to, the system memory 1206 to the processing unit 1204. The processing unit 1204 can be any of various commercially available processors. Dual microprocessors and other multi-processor architectures can also be employed as the processing unit 1204.

The system bus 1208 can be any of several types of bus structure that can further interconnect to a memory bus (with or without a memory controller), a peripheral bus, and a local bus using any of a variety of commercially available bus architectures. The system memory 1206 includes ROM 1210 and RAM 1212. A basic input/output system (BIOS) can be stored in a non-volatile memory such as ROM, erasable programmable read only memory (EPROM), EEPROM, which BIOS contains the basic routines that help to transfer information between elements within the computer 1202, such as during startup. The RAM 1212 can also include a high-speed RAM such as static RAM for caching data.

The computer 1202 further includes an internal hard disk drive (HDD) 1214 (e.g., EIDE, SATA), one or more external storage devices 1216 (e.g., a magnetic floppy disk drive (FDD) 1216, a memory stick or flash drive reader, a memory card reader, etc.) and an optical disk drive 1220 (e.g., which can read or write from a CD-ROM disc, a DVD, a BD, etc.). While the internal HDD 1214 is illustrated as located within the computer 1202, the internal HDD 1214 can also be configured for external use in a suitable chassis (not shown). Additionally, while not shown in environment 1200, a solid-state drive (SSD) could be used in addition to, or in place of, an HDD 1214. The HDD 1214, external storage device(s) 1216 and optical disk drive 1220 can be connected to the system bus 1208 by an HDD interface 1224, an external storage interface 1226 and an optical drive interface 1228, respectively. The interface 1224 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer executable instructions, and so forth. For the computer 1202, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer executable instructions for performing the methods described herein.

A number of program modules can be stored in the drives and RAM 1212, including an operating system 1230, one or more application programs 1232, other program modules 1234 and program data 1236. All or portions of the operating system, applications, modules, and/or data can also be cached in the RAM 1212. The systems and methods described herein can be implemented utilizing various commercially available operating systems or combinations of operating systems.

Computer 1202 can optionally comprise emulation technologies. For example, a hypervisor (not shown) or other intermediary can emulate a hardware environment for operating system 1230, and the emulated hardware can optionally be different from the hardware illustrated in FIG. 12. In such an embodiment, operating system 1230 can comprise one virtual machine (VM) of multiple VMs hosted at computer 1202. Furthermore, operating system 1230 can provide runtime environments, such as the Java runtime environment or the .NET framework, for applications 1232. Runtime environments are consistent execution environments that allow applications 1232 to run on any operating system that includes the runtime environment. Similarly, operating system 1230 can support containers, and applications 1232 can be in the form of containers, which are lightweight, standalone, executable packages of software that include, e.g., code, runtime, system tools, system libraries and settings for an application.

Further, computer 1202 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1202, e.g., applied at the application execution level or at the operating system (OS) kernel level, thereby enabling security at any level of code execution.

A user can enter commands and information into the computer 1202 through one or more wired/wireless input devices, e.g., a keyboard 1238, a touch screen 1240, and a pointing device, such as a mouse 1242. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1204 through an input device interface 1244 that can be coupled to the system bus 1208, but can be connected by other interfaces, such as a parallel port, an IEEE 1394 serial port, a game port, a USB port, an IR interface, a BLUETOOTH® interface, etc.

A monitor 1246 or other type of display device can also be connected to the system bus 1208 via an interface, such as a video adapter 1248. In addition to the monitor 1246, a computer typically includes other peripheral output devices (not shown), such as speakers, printers, etc.

The computer 1202 can operate in a networked environment using logical connections via wired and/or wireless communications to one or more remote computers, such as a remote computer(s) 1250. The remote computer(s) 1250 can be a workstation, a server computer, a router, a personal computer, portable computer, microprocessor-based entertainment appliance, a peer device or other common network node, and typically includes many or all of the elements described relative to the computer 1202, although, for purposes of brevity, only a memory/storage device 1252 is illustrated. The logical connections depicted include wired/wireless connectivity to a local area network (LAN) 1254 and/or larger networks, e.g., a wide area network (WAN) 1256. Such LAN and WAN networking environments are commonplace in offices and companies, and facilitate enterprise-wide computer networks, such as intranets, all of which can connect to a global communications network, e.g., the Internet.

When used in a LAN networking environment, the computer 1202 can be connected to the local network 1254 through a wired and/or wireless communication network interface or adapter 1258. The adapter 1258 can facilitate wired or wireless communication to the LAN 1254, which can also include a wireless access point (AP) disposed thereon for communicating with the adapter 1258 in a wireless mode.

When used in a WAN networking environment, the computer 1202 can include a modem 1260 or can be connected to a communications server on the WAN 1256 via other means for establishing communications over the WAN 1256, such as by way of the Internet. The modem 1260, which can be internal or external and a wired or wireless device, can be connected to the system bus 1208 via the input device interface 1244. In a networked environment, program modules depicted relative to the computer 1202 or portions thereof, can be stored in the remote memory/storage device 1252. It will be appreciated that the network connections shown are example and other means of establishing a communications link between the computers can be used.

When used in either a LAN or WAN networking environment, the computer 1202 can access cloud storage systems or other network-based storage systems in addition to, or in place of, external storage devices 1216 as described above. Generally, a connection between the computer 1202 and a cloud storage system can be established over a LAN 1254 or WAN 1256 e.g., by the adapter 1258 or modem 1260, respectively. Upon connecting the computer 1202 to an associated cloud storage system, the external storage interface 1226 can, with the aid of the adapter 1258 and/or modem 1260, manage storage provided by the cloud storage system as it would other types of external storage. For instance, the external storage interface 1226 can be configured to provide access to cloud storage sources as if those sources were physically connected to the computer 1202.

The computer 1202 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations,” this could include the processor performing the operations directly and/or facilitating, directing, or cooperating with another device or component to perform the operations.

In the subject specification, terms such as “datastore,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or application program interface (API) components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical discs (e.g., CD, DVD . . . ), smart cards, and flash memory devices (e.g., card, stick, key drive . . . ). Of course, those skilled in the art will recognize many modifications can be made to this configuration without departing from the scope or spirit of the various embodiments.

Moreover, terms like “user equipment (UE),” “mobile station,” “mobile,” subscriber station,” “subscriber equipment,” “access terminal,” “terminal,” “handset,” and similar terminology, refer to a wireless device utilized by a subscriber or user of a wireless communication service to receive or convey data, control, voice, video, sound, gaming, or substantially any data-stream or signaling-stream. The foregoing terms are utilized interchangeably in the subject specification and related drawings. Likewise, the terms “network device,” “access point (AP),” “base station,” “NodeB,” “evolved Node B (eNodeB),” “home Node B (HNB),” “home access point (HAP),” “cell device,” “sector,” “cell,” and the like, are utilized interchangeably in the subject application, and refer to a wireless network component or appliance that can serve and receive data, control, voice, video, sound, gaming, or substantially any data-stream or signaling-stream to and from a set of subscriber stations or provider enabled devices. Data and signaling streams can include packetized or frame-based flows.

Additionally, the terms “core-network,” “core,” “core carrier network,” “carrier-side,” or similar terms can refer to components of a telecommunications network that typically provides some or all of aggregation, authentication, call control and switching, charging, service invocation, or gateways. Aggregation can refer to the highest level of aggregation in a service provider network wherein the next level in the hierarchy under the core nodes is the distribution networks and then the edge networks. User equipment does not normally connect directly to the core networks of a large service provider but can be routed to the core by way of a switch or radio area network. Authentication can refer to determinations regarding whether the user requesting a service from the telecom network is authorized to do so within this network or not. Call control and switching can refer determinations related to the future course of a call stream across carrier equipment based on the call signal processing. Charging can be related to the collation and processing of charging data generated by various network nodes. Two common types of charging mechanisms found in present day networks can be prepaid charging and postpaid charging. Service invocation can occur based on some explicit action (e.g., call transfer) or implicitly (e.g., call waiting). It is to be noted that service “execution” may or may not be a core network functionality as third-party network/nodes may take part in actual service execution. A gateway can be present in the core network to access other networks. Gateway functionality can be dependent on the type of the interface with another network.

Furthermore, the terms “user,” “subscriber,” “customer,” “consumer,” “prosumer,” “agent,” and the like are employed interchangeably throughout the subject specification, unless context warrants particular distinction(s) among the terms. It should be appreciated that such terms can refer to human entities or automated components (e.g., supported through artificial intelligence, as through a capacity to make inferences based on complex mathematical formalisms), that can provide simulated vision, sound recognition and so forth.

Aspects, features, or advantages of the subject matter can be exploited in substantially any, or any, wired, broadcast, wireless telecommunication, radio technology or network, or combinations thereof. Non-limiting examples of such technologies or networks include Geocast technology; broadcast technologies (e.g., sub-Hz, ELF, VLF, LF, MF, HF, VHF, UHF, SHF, THz broadcasts, etc.); Ethernet; X.25; powerline-type networking (e.g., PowerLine AV Ethernet, etc.); femto-cell technology; Wi-Fi; Worldwide Interoperability for Microwave Access (WiMAX); Enhanced General Packet Radio Service (Enhanced GPRS); Third Generation Partnership Project (3GPP or 3G) Long Term Evolution (LTE); 3GPP Universal Mobile Telecommunications System (UMTS) or 3GPP UMTS; Third Generation Partnership Project 2 (3GPP2) Ultra Mobile Broadband (UMB); High Speed Packet Access (HSPA); High Speed Downlink Packet Access (HSDPA); High Speed Uplink Packet Access (HSUPA); GSM Enhanced Data Rates for GSM Evolution (EDGE) RAN or GERAN; UMTS Terrestrial Radio Access Network (UTRAN); or LTE Advanced.

The above description includes non-limiting examples of the various embodiments. It is, of course, not possible to describe every conceivable combination of components or methodologies for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

With regard to the various functions performed by the above described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such features may be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any embodiment or design described herein as “exemplary” and/or “demonstrative” is not necessarily to be construed as preferred or advantageous over other embodiments or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive-in a manner similar to the term “comprising” as an open transition word-without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A method, comprising:
identifying, by a workload controller system comprising at least one processor, a processing workload and a container orchestration system;
communicating, by the workload controller system, a deployment request to a container controller of the container orchestration system to deploy the processing workload, in accordance with a custom resource pool operator of the container orchestration system, wherein the deployment request comprises:
a first request to the container controller to create a resource pool comprising at least one processing container and corresponding to a namespace,
a second request to deploy the processing workload to the least one processing container, and
a third request to the container controller to apply an affinity label that specifies to the container controller to host the processing workload in at the least one processing container corresponding to the namespace; and
validating, by the workload controller system, deployment of the processing workload to the at least one processing container corresponding to the namespace.

2. The method of claim 1, wherein the resource pool comprises a custom resource of the container orchestration system.

3. The method of claim 2, wherein the resource pool operator is applicable to request the container controller to validate that inclusion of the at least one processing container in the resource pool does not exceed an upper limit on number of available processing containers.

4. The method of claim 2, wherein the at least one processing container corresponds to a computer system comprised in a cluster of computer systems hosting the container orchestration system.

5. The method of claim 2, wherein the deployment request further comprises:
a fourth request to the container controller to apply a restriction to the at least one processing container of the resource pool, and wherein the restriction specifies, to the container controller, not to allocate any other processing workloads other than the processing workload to the at least one processing container of the resource pool, and
a fifth request to the container controller to apply a toleration indication to the at least one processing container of the resource pool, wherein the toleration indication specifies, to the container controller, that the at least one processing container of the resource pool is permitted to host the processing workload.

6. The method of claim 5, wherein the custom resource pool operator is applicable to request the container controller to create a resource quota custom data object in the namespace, the resource quota custom data object being applicable to limit resources assigned to the at least one processing container of the namespace.

7. The method of claim 6, wherein the resource quota object is further applicable to provide, to the processing workload, resource information corresponding to resources assigned to the at least one processing container of the namespace.

8. The method of claim 7, further comprising:
receiving, by the workload controller system, a modification request to modify a number of the at least one processing container available to process the processing workload; and
employing, by the workload controller system, the custom resource pool operator to alter a number of the least one processing container comprised in the namespace, resulting in an altered number of processing containers comprised in the namespace, wherein, as a result of carrying out the modification request, the resource quota custom data object is configured to update the resource information.

9. The method of claim 8, wherein, based on the modification request, the resource quota custom data object is further configured to, based on the altered number of processing containers:
update a number of restrictions applied to the at least one processing container of the resource pool, and
update a number of toleration indications applied to the at least one processing container of the resource pool.

10. The method of claim 1, wherein the processing workload comprises at least one of a distributed query process workload, or a distributed workflow process workload.

11. The method of claim 1, wherein the container orchestration system comprises an open-source container orchestration system.

12. Container management equipment, comprising:
at least one memory that stores computer executable instructions; and
at least one processor configured to process the computer executable instructions that, when executed by the at least one processor, facilitate performance of operations, comprising:
receiving, from workload management controller equipment of a container management system, an object request to generate a node pool custom data object, wherein the object request specifies, for a workload application, an application namespace, and nodes comprised in the application namespace that support processing of the workload application;
receiving, from the workload management controller equipment, an operator request to generate a node pool custom operator to manage the node pool custom data object in the container management system; and
based on the node pool custom operator:
restricting the nodes from being included in a different application namespace, and
deploying the workload application to the nodes.

13. The container management equipment of claim 12, wherein the restricting of the nodes comprises applying a taint to the nodes.

14. The container management equipment of claim 12, wherein the operations further comprise, based further on the node pool custom operator, applying an affinity label to the nodes, and wherein the deploying of the workload application to the nodes comprises, based on the affinity label, deploying the workload application to the nodes.

15. The container management equipment of claim 12, wherein the operations further comprise, based further on the node pool custom operator, applying, to the workload application, a tolerance indication applicable to the application namespace, and wherein the deploying of the workload application to the nodes comprises, based on the tolerance indication, deploying the workload application to the nodes.

16. The container management equipment of claim 12, wherein the operations further comprise, based further on the node pool custom operator, generating a custom resource quota object applicable to monitoring resources applied to the nodes.

17. A non-transitory machine-readable medium comprising executable instructions that, when executed by at least one processor of a computing system, facilitate performance of operations, the operations comprising:
generating a custom container pool object of a container orchestration system comprising a namespace of processing nodes applicable to process a workload application;
based on a custom container pool operator, deploying the workload application to the namespace; and
based on a custom resource quota operator, modifying the processing nodes comprised in the namespace, wherein the modifying of the processing nodes comprises:
modifying a taint applied to a first processing node of the processing nodes,
modifying an affinity applied to a second processing node of the processing nodes.

18. The non-transitory machine-readable medium of claim 17, wherein the operations further comprise:
based further on the custom resource quota operator, validating hosting of the workload application by the processing nodes.

19. The non-transitory machine-readable medium of claim 17, wherein the operations further comprise, based further on the custom resource quota operator, configuring the container orchestration system to prevent a change to a parameter of the processing nodes without use of the custom resource quota operator.

20. The non-transitory machine-readable medium of claim 17, wherein the container orchestration system comprises a Kubernetes container orchestration system, and wherein the processing nodes comprise worker nodes of the Kubernetes container orchestration system.
